(19) United States
(12) Patent Application Publication
(10) Pub. No.: US 2026/0103039 A1
(43) Pub. Date: Apr. 16, 2026

(54) OVERHEIGHT ASSEMBLY FOR AN AIR SUSPENSION SYSTEM

(71) Applicant: Jeffrey James Kelderman, Oskaloosa, IA (US)

(72) Inventor: Jeffrey James Kelderman, Oskaloosa, IA (US)

(21) Appl. No.: 19/354,372

(22) Filed: Oct. 9, 2025

Related U.S. Application Data
(60) Provisional application No. 63/705,649, filed on Oct. 10, 2024.

(51) Int. Cl. B60G 17/0165; B60G 17/015

(52) U.S. Cl. CPC B60G 17/0165; B60G 17/0155; B60G 2500/30

(57) ABSTRACT

The disclosure provided herein is directed to an overheight assembly to selectively raise an air suspension of a vehicle. The assembly may include a dynamic assembly received at least partially within a vehicle mount assembly. The assembly may include an actuator assembly operatively connected to the dynamic assembly. The assembly may include a mount assembly dynamically connected to the dynamic assembly. The assembly may transition between a standard configuration and an overheight configuration, whereby the actuator assembly actuates the dynamic assembly to change the orientation of the mount assembly thereby instigating an overheight control valve to inflate or exhaust the air suspension.

### CROSS REFERENCE TO RELATED APPLICATION

This application claims the benefit of U.S. Provisional Application Ser. No. 63/705,649 filed Oct. 10, 2024, the contents of this application is hereby incorporated by reference in its entirety.

### BACKGROUND OF THE INVENTION

This disclosure generally relates to an air suspension system. More specifically, the disclosure relates to an overheight assembly for an air suspension system.

Air ride suspensions are known in the art and commonly comprise an air supply, at least one air bag, and at least one height control valve. The height control valve maintains a vehicle's ride height between a frame and an axle of the vehicle. This is accomplished by a control arm of the height control valve. The height control valve is conventionally rigidly mounted in a fixed position to the frame of the vehicle, which is sometimes accomplished with a bracket, while the control arm is alterably connected to the height control valve at one end and fixedly connected to a linkage extending between the control arm and the axle of the vehicle. When the ride distance between the axle and frame is reduced, such as by a load being added to the vehicle, the control arm is displaced, and air is pumped to the airbag to return to the original ride height. Similarly, should the distances between the frame and axle increase, such as by a load being removed from the vehicle, the control arm is displaced in an opposite manner to vent air from the airbag via an exhaust port until the original ride height is achieved and the control arm returns to a neutral position. In these ways, the ride height remains level.

While air suspension systems are useful, problems exist. Particularly, the use of an air suspension system on a semi tractor with a low-clearance bumper. Low-clearance bumpers are popular given the aesthetic they provide to the tractor. When a load is being transported through a field, over speed bumps, over a pothole, or other unlevel terrain, the low-clearance bumper can be damaged as existing air suspension systems do not account for such encounters. As such, there is a need to overcome this disadvantage.

Thus it is a primary aspect of this disclosure to provide an overheight assembly of an air suspension system that improves upon the art.

Another aspect of this disclosure is to provide an overheight assembly that can be easily retrofitted into an existing air ride suspension.

Yet another aspect of this disclosure is to provide an overheight assembly that is simple to install, simple to use and cost-effective.

Yet another aspect of this disclosure is to provide an overheight assembly that does not require additional valving.

These and other aspects, features, and advantages of the invention will become apparent from the specification and claims.

### SUMMARY OF THE INVENTION

The disclosure provides various aspects of an overheight assembly for an air suspension system.

In some aspects, the techniques described herein relate to an overheight assembly for an air suspension system including: a dynamic assembly received at least partially within a vehicle mount assembly; an actuator assembly operatively connected to the dynamic assembly; and a mount assembly dynamically connected to the dynamic assembly.

In some aspects, the techniques described herein relate to an overheight assembly further including a height controller mounted to the mount assembly.

In some aspects, the techniques described herein relate to an overheight assembly further including the height controller connected to an axle of a vehicle and the vehicle mount assembly mounted to the vehicle above the axle.

In some aspects, the techniques described herein relate to an overheight assembly further including the dynamic assembly having a standard configuration and an overheight configuration, wherein an orientation of the height controller in relation to the axle and the vehicle mount assembly is different for the standard configuration and the overheight configuration.

In some aspects, the techniques described herein relate to an overheight assembly further including the dynamic assembly having a rotator and a rotator shaft timed to one another by a first key.

In some aspects, the techniques described herein relate to an overheight assembly further including the rotator shaft timed to the mount assembly by a second key.

In some aspects, the techniques described herein relate to an overheight assembly wherein the first key is received in a first key channel of the rotator and an elongated key channel of the rotator shaft; and the second key is received in a second key channel of the mount assembly and the elongated key channel of the rotator shaft.

In some aspects, the techniques described herein relate to an overheight assembly further including the dynamic assembly having a rotator shaft that extends through a rotator, a bearing, and a sidewall of the vehicle mount assembly to at least partially within the mount assembly.

In some aspects, the techniques described herein relate to an overheight assembly further including a retainer received in an end of the rotator shaft; and the mount assembly positioned between a retainer ring of the retainer and the rotator shaft.

In some aspects, the techniques described herein relate to an overheight assembly further including the rotator shaft having a cap connected to an opposite end of the rotator shaft, wherein the cap is received in a cap recess inside of the vehicle mount assembly.

In some aspects, the techniques described herein relate to an overheight assembly further including the dynamic assembly having a trunnion having trunnion body and a pair of trunnion arms extending from opposite sides of the trunnion body; the trunnion arms received through a trunnion slot that extends through a first rotator arm and a second rotator arm of a rotator.

In some aspects, the techniques described herein relate to an overheight assembly further including one of the pair of trunnion arms received in a first arm channel within a housing of the vehicle mount assembly; and the other of the pair of trunnion arms received in a second arm channel within the housing.

In some aspects, the techniques described herein relate to an overheight assembly further including the vehicle mount assembly having a housing with a cavity; a side wall within the housing having a bearing recess, a bearing retainer recess, and a shaft opening.

In some aspects, the techniques described herein relate to an overheight assembly further including the side wall of the housing having a drip edge encircling the shaft opening; wherein the drip edge protrudes from an exterior surface of the side wall.

In some aspects, the techniques described herein relate to an overheight assembly further including the mount assembly having a mount collar that extends from a mount plate; wherein the mount collar is press fit within the drip edge.

In some aspects, the techniques described herein relate to an overheight assembly further including the housing have a housing cover with a cap recess; and the housing having a bias member compartment on a front wall and an actuator opening through a rear wall.

In some aspects, the techniques described herein relate to an overheight assembly further including the actuator assembly having an actuator operatively connected to trunnion of the dynamic assembly; and a bias member connected to the trunnion opposite of the actuator.

In some aspects, the techniques described herein relate to an overheight assembly wherein the bias member is an expansion bias spring.

In some aspects, the techniques described herein relate to an overheight assembly further including the trunnion having a trunnion plate that is received within an end of the expansion bias spring.

This has outlined, rather broadly, the features, advantages, solutions, and benefits of the disclosure in order that the description that follows may be better understood. Additional features, advantages, solutions, and benefits of the disclosure will be described in the following. It should be appreciated by those skilled in the art that this disclosure may be readily utilized as a basis for modifying or designing other structures and related operations for carrying out the same purposes of the present disclosure. It should also be realized by those skilled in the art that such equivalent constructions and related operation do not depart from the teachings of the disclosure as set forth in the appended claims. The novel features, together with further objects and advantages, will be better understood from the following description when considered in connection with the accompanying Figures. It is to be expressly understood, however, that each of the Figures is provided for the purpose of illustration and description only and is not intended as a definition of the limits of the present disclosure.

### BRIEF DESCRIPTION OF THE DRAWINGS

FIG. 1 is a perspective view of an overheight assembly for an air suspension system according to an aspect of the disclosure;

FIG. 2 is a perspective view of an overheight assembly for an air suspension system according to an aspect of the disclosure;

FIG. 3 is an exploded view of an overheight assembly for an air suspension system according to an aspect of the disclosure;

FIG. 4 is a side view of an overheight assembly for an air suspension system according to an aspect of the disclosure;

FIG. 5 is a side view of an overheight assembly for an air suspension system according to an aspect of the disclosure;

FIG. 6 is a side view of an overheight assembly for an air suspension system according to an aspect of the disclosure;

FIG. 7 is a cross-sectional view of an overheight assembly for an air suspension system according to an aspect of the disclosure as indicated in FIG. 6;

FIG. 8 is a partial cross-sectional view of an overheight assembly for an air suspension system according to an aspect of the disclosure as indicated in FIG. 7;

FIG. 9 is a perspective view of an overheight assembly for an air suspension system according to an aspect of the disclosure;

FIG. 10 is a perspective view of an overheight assembly for an air suspension system according to an aspect of the disclosure;

FIG. 11 is a perspective view of an overheight assembly for an air suspension system according to an aspect of the disclosure;

FIG. 12 is a perspective view of an overheight assembly for an air suspension system according to an aspect of the disclosure;

FIG. 13 is a perspective view of an overheight assembly for an air suspension system according to an aspect of the disclosure;

FIG. 14 is a perspective view of an overheight assembly for an air suspension system according to an aspect of the disclosure;

FIG. 15 is a perspective view of an overheight assembly for an air suspension system according to an aspect of the disclosure;

FIG. 16 is a perspective view of an overheight assembly for an air suspension system according to an aspect of the disclosure;

FIG. 17 is a side view of an overheight assembly for an air suspension system according to an aspect of the disclosure;

FIG. 18 is a side view of an overheight assembly for an air suspension system according to an aspect of the disclosure;

FIG. 19 is a side view of an overheight assembly for an air suspension system according to an aspect of the disclosure;

FIG. 20 is a side view of an overheight assembly for an air suspension system according to an aspect of the disclosure; and

FIG. 21 is a side view of an overheight assembly for an air suspension system according to an aspect of the disclosure.

### DETAILED DESCRIPTION

The disclosure described herein is directed to different aspects of an overheight system for an air suspension system. The detailed description set forth below, in connection with the appended drawings, is intended as a description of various configurations and is not intended to represent the only configurations in which the concepts described herein may be practiced. These descriptions include specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The disclosure is described herein with reference to certain aspects, iterations, embodiments, and examples but it is understood that the disclosure can be embodied in many different forms and should not be construed as limited to the aspects set forth herein. For instance, the height control mechanism addressed herein is a valve with a control arm that activates and deactivates operation of the height control mechanism. Alternative structures are contemplated for the height control mechanism that can be manipulated to operate unconventionally by dynamically altering their orientation and/or position.

Although the terms first, second, etc. may be used herein to describe various elements or components, these elements or components should not be limited by these terms. These terms are only used to distinguish one element or component from another. Hence, a first element discussed herein could be termed a second element without departing from the teachings of the present application. It is understood that actual systems or fixtures embodying the disclosure can be arranged in many different ways with many more features and elements beyond what is shown in the drawings. For the same or similar elements or features, the same reference numbers may be used throughout the disclosure.

It is to be understood that when an element or component is referred to as being “on” another element or component, it can be directly on the other element or intervening elements may also be present. Furthermore, relative terms such as “between”, “within”, “below”, and similar terms, may be used herein to describe a relationship of one element or component to another. It is understood that these terms are intended to encompass different orientations of the disclosure in addition to the orientation depicted in the figures.

Aspects of the disclosure may be described herein with reference to illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region of a device and are not intended to limit the scope of the disclosure.

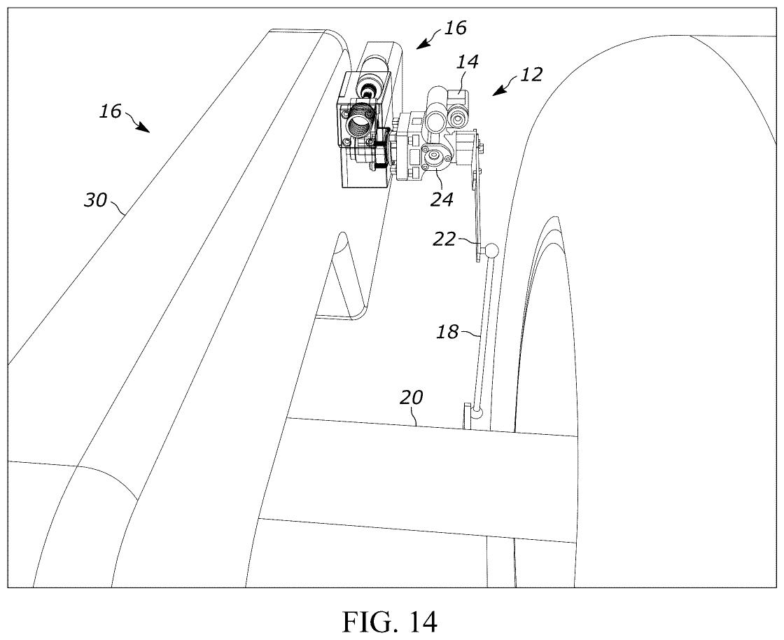

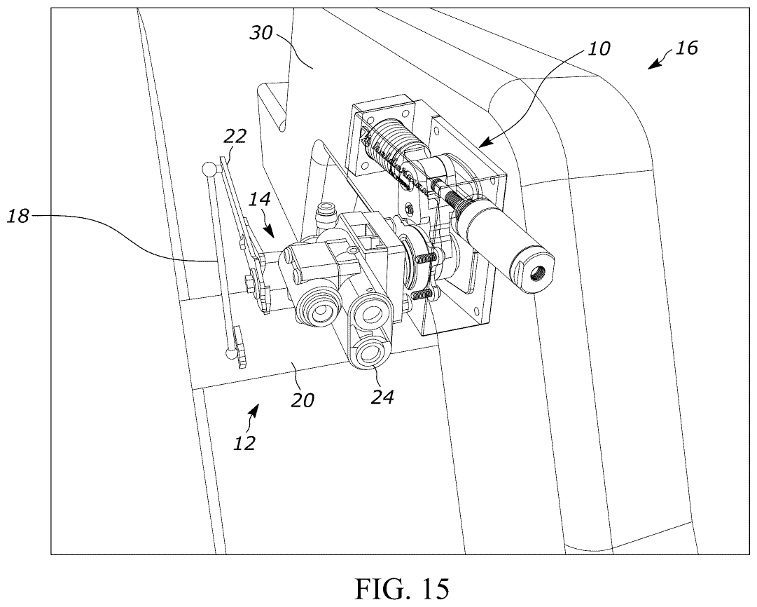

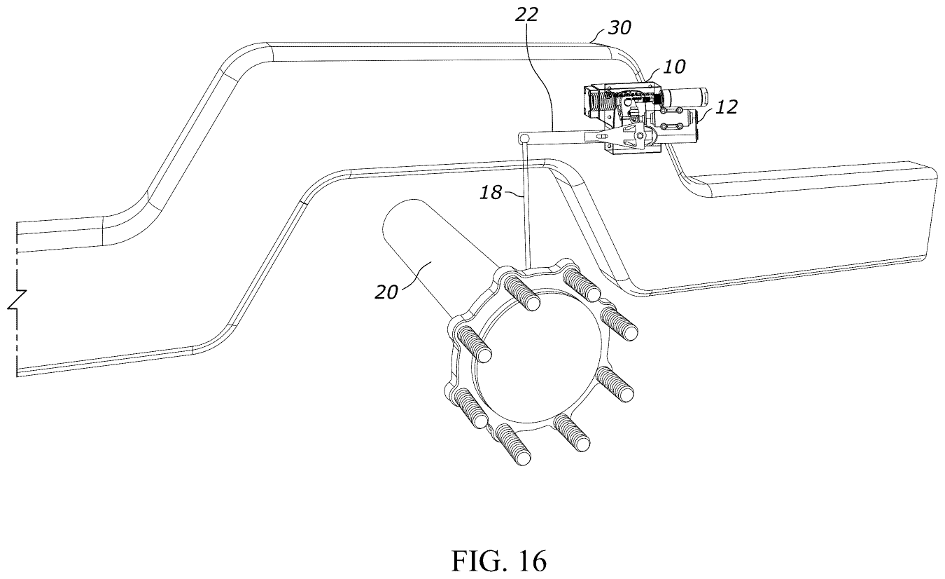

With reference to the Figures aspects of an overheight assembly 10 for an air suspension system 12 are shown according to the disclosure. With particular reference to at least FIGS. 14-21, the air suspension system 12 may comprise one or more of a height controller or a height control valve 14 operatively connected to the air suspension system 12 of a vehicle 16 by a linkage 18 that connects to an axle 20 of the vehicle 16. The height control valve 14 may comprise a control arm 22 that connects to the linkage 18 and a valve body 24.

The overheight assembly 10 may comprise one or more of a dynamic assembly 26 configured to selectively change the orientation of the valve body 24, a vehicle mount assembly 28 configured to mount the dynamic assembly 26 to the vehicle 16 (such as on a frame 30 of the vehicle 16 above the axle 20), a mount assembly 32 configured to mount the height control valve 14 to the overheight assembly 10, and an actuator assembly 34 configured to actuate the dynamic assembly 26.

The dynamic assembly 26 may comprise one or more of a trunnion 36, a bias member 38, which as depicted may be a spring with an expansion bias, a rotator 40 that may comprise a first rotator arm 42 and a second rotator arm 44, a rotator shaft 46, a bearing retainer 48, a bearing 50, and a retainer 52. In aspects of the overheight assembly 10 in which a spring is utilized, the spring rate may be twenty-three (23) lbs/in. (such as that provided by 72570CS compressed spring available from Century Spring,®) which is critical to provide sufficient force to keep the rotator 40 from accidentally rotating due to road vibrations while allowing an air cylinder with ninety (90) psi to overpower the spring when activated.

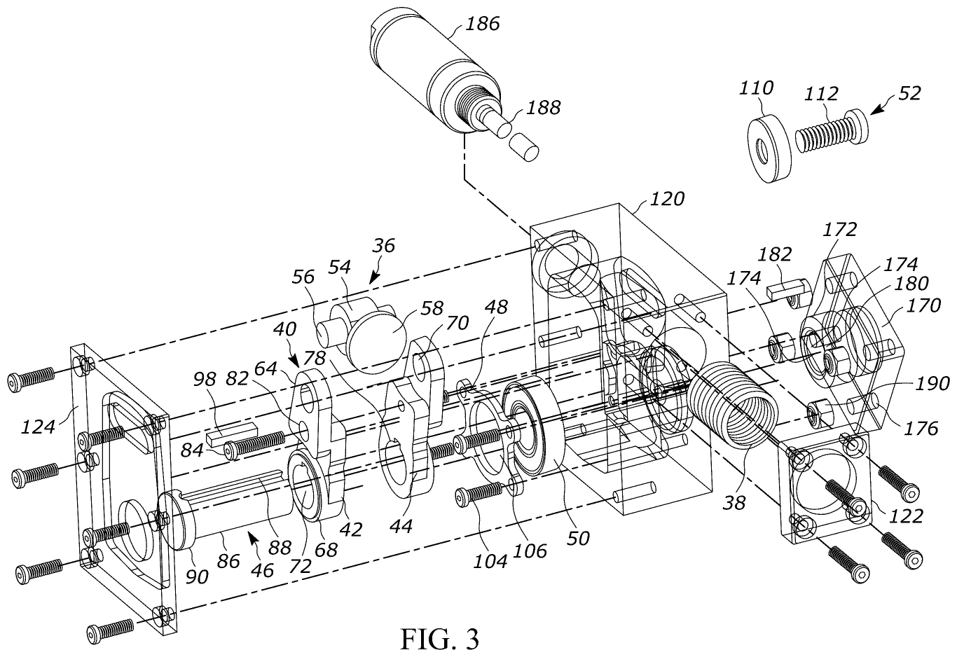

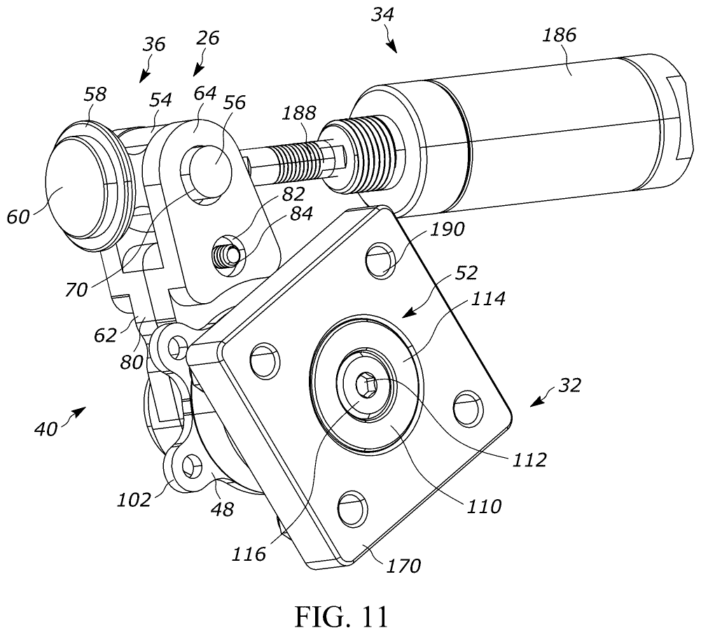

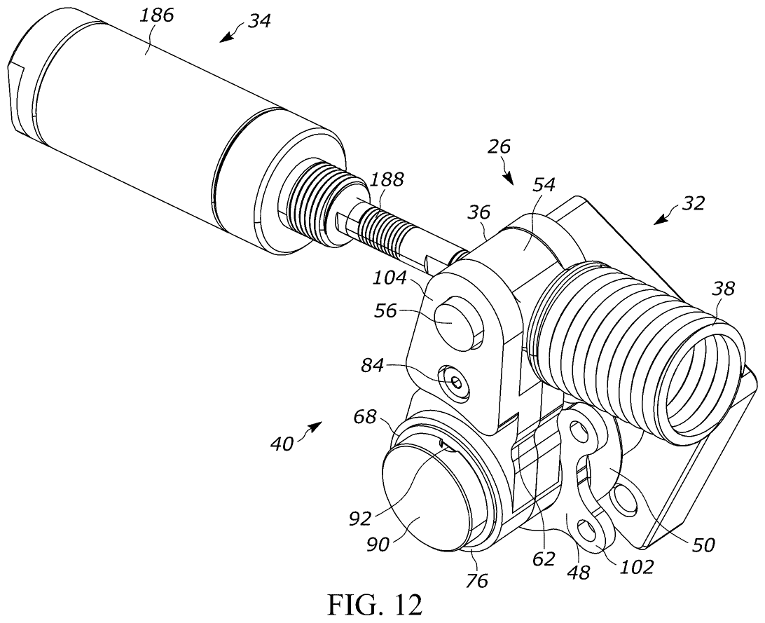

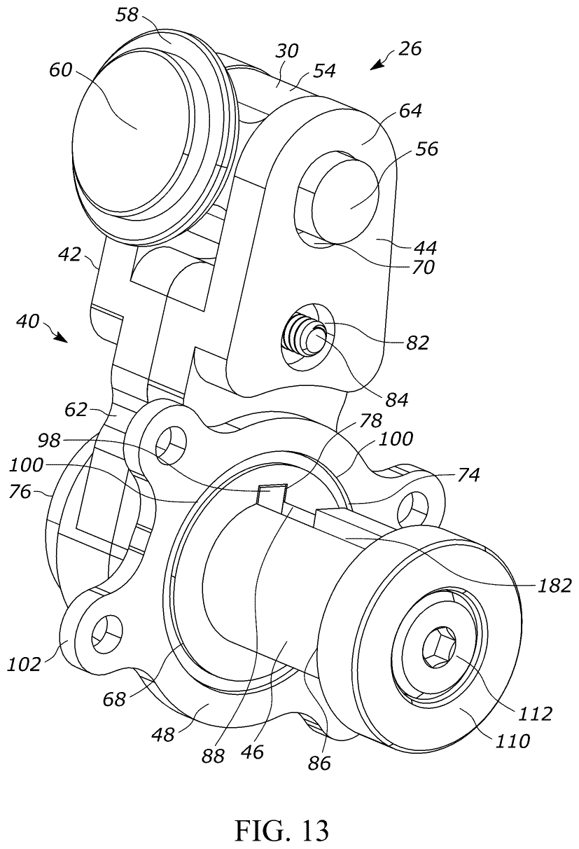

The trunnion 36 may have a trunnion body 54 from which one or a pair of trunnion arms 56 extend outwardly. The trunnion 36 may be made of steel to obtain the advantage of strength, rigidity, and durability. When a pair of trunnion arms 56 are present, the pair of trunnion arms 56 may extend out from the trunnion body 54 in opposite directions. A trunnion plate 58 may extend from the trunnion body 54, which may extend perpendicularly to and from a position between the pair of trunnion arms 56. The trunnion plate 58 may have a trunnion protrusion 60 that is configured to engage the bias member 38. With reference to at least FIGS. 3, 11, and 13, the trunnion protrusion 60 may be circular so that the trunnion protrusion 60 is received within one end of the bias member 38 while the trunnion plate 58 engages the end of the bias member 38, such as when the bias member 38 is a spring.

The rotator 40 may have a rotator body 62 from which a pair of flanges 64 extend from one end in spaced alignment and/or a shaft collar 68 protrudes from the other end. The rotator 40 may be made of aluminum to resist corrosion and ease manufacture. A trunnion opening 70 may extend through the pair of flanges 64 and may receive the one or pair of trunnion arms 56. The one or pair of trunnion arms 56 may be rotatably received within the trunnion opening 70, and with reference to at least FIGS. 3-5, 11, and 13, the one or pair of trunnion arms 56 may extend through and beyond the trunnion opening 70, which may facilitate operation as discussed further herein. The trunnion opening 70 may be formed as an elongated slot that extends vertically to allow vertical deviation between the trunnion 36 and the rotator 40 as the trunnion 36 travels horizontally as disclosed herein during operation of the overheight assembly 10.

The shaft collar 68 may have a shaft opening 72 extending therethrough and may have a first rim 74 and/or a second rim 76 that extends beyond the rotator body 62 such that the shaft collar 68 extends outwardly from and perpendicularly to a length of the rotator body 62. The shaft collar 68 may have a first key channel 78 recessed in a diameter of the shaft collar 68 along a length of the shaft opening 72. The first key channel 78 may be formed as a rectangular recess.

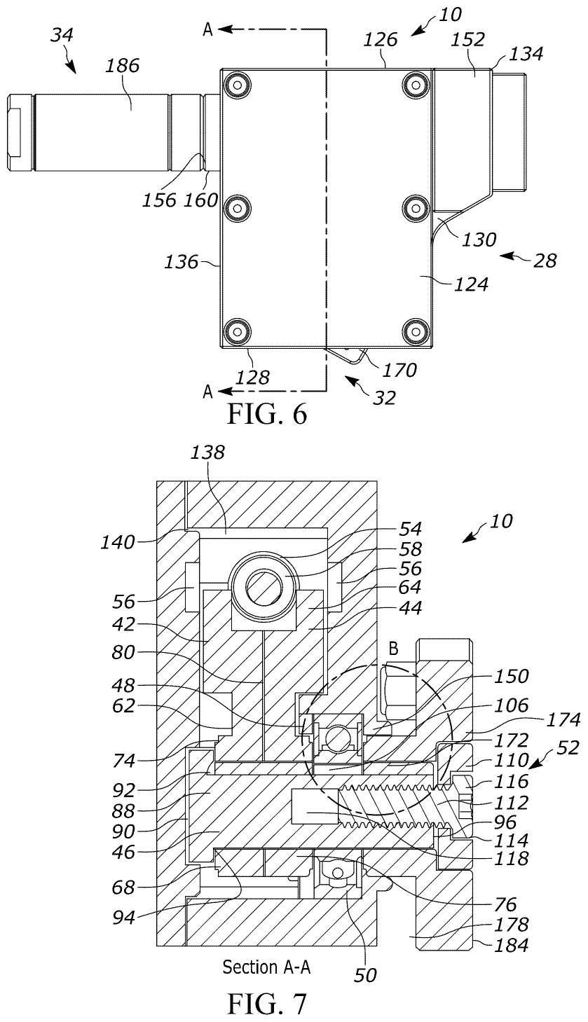

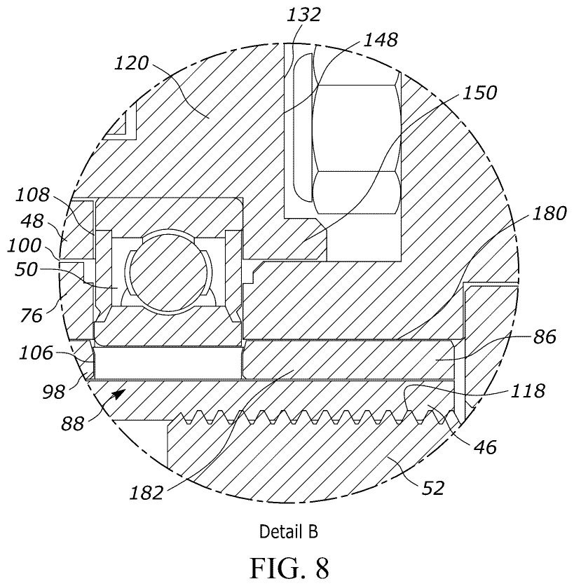

In aspects of the overheight assembly 10 in which the rotator 40 is comprised of the first rotator arm 42 and the second rotator arm 44, the rotator body 62 may be divided symmetrically or asymmetrically along respective interior faces 80 to form the first rotator arm 42 and the second rotator arm 44. In some configurations, the first rotator arm 42 and the second rotator arm 44 may mirror one another as seen in at least FIGS. 3, 6-8, and 11-14. A rotator arm opening 82 may extend through the first rotator arm 42 and the second rotator arm 44 in a direction perpendicular to a length of the respective interior faces 80. A rotator arm connector 84 may be received through the rotator arm opening 82 to connect the first rotator arm 42 and the second rotator arm 44 to one another. When the rotator 40 is comprised of the first rotator arm 42 and the second rotator arm 44, assembly of the rotator 40 with the trunnion 36 is facilitated due to the insertion of the trunnion arms 56 into the trunnion opening 70 of the rotator 40 before the first rotator arm 42 and the second rotator arm 44 are secured to one another.

The rotator shaft 46 may comprise one or more of an elongated shaft 86, an elongated key channel 88, a cap 90, and a cap notch 92. The rotator shaft 46 may be made of steel for strength and accurate timing as disclosed herein. The cap 90 may connect to the elongated shaft 86 at a first end 94. The elongated key channel 88 may extend from the first end 94 to a second end 96 of the elongated shaft 86, such that the elongated key channel 88 terminates where the elongated key channel 88 terminates at the second end 96. The elongated key channel 88 may extend into the cap 90, such that the elongated key channel 88 forms into the cap notch 92 in the cap 90. The elongated key channel 88 may be formed as a rectangular recess. A first key 98, which may be formed as a rectangular prism or cuboid, may be received within the elongated key channel 88 and may also be received, at least partially, within the cap notch 92.

The rotator shaft 46 may be received through the shaft opening 72 of the rotator 40, whereby the first key 98 is received the first key channel 78 of the shaft opening 72. In this way, the rotator 40 to the rotator shaft 46 are timed with one another. The first key 98 may be sized and shaped to extend a length no greater a distance extending from the cap 90 or cap notch 92 to the end of the second rim 76, such that the first key 98 does not extend beyond the shaft collar 68 when the rotator shaft 46 is received through the shaft collar 68 and the first rim 74 of the shaft collar 68 engages the cap 90 to prevent the rotator shaft 46 from passing through the shaft collar 68.

The bearing retainer 48 may comprise one or more of a retainer opening 100 and one or a plurality of connector flanges 102. The second rim 76 of the shaft collar 68 may be received through the retainer opening 100. The bearing retainer 48 may be sized and shaped that when in place and in engagement with the rotator 40, the bearing retainer 48 encircles the second rim 76. The plurality of connector flanges 102 may connect to the vehicle mount assembly 28 as discussed further herein with one or more of a bearing retainer connector 104 within each of the plurality of connector flanges 102. The bearing retainer 48 may, alternatively, be a snap ring, however, as disclosed the bearing retainer 48 has a simpler manufacture and assembly for the overheight assembly 10.

The rotator shaft 46 is also received through the retainer opening 100 and may also pass through a bearing opening 106 of the bearing 50. When the bearing 50 is in place on the rotator shaft 46, a bearing face 108 is engaged to the second rim 76 of the rotator 40 and the bearing retainer 48. The rotator shaft 46 may also extend through and beyond the vehicle mount assembly 28 and/or within or beyond the mount assembly 32 as disclosed further herein.

The retainer 52 may comprise one or more of a retainer ring 110 and a retainer connector 112. The retainer ring 110 may be a washer and the retainer connector 112 may be a screw. The retainer ring 110 may be placed at the second end 96 of the elongated shaft 86 opposite the cap 90. The retainer ring 110 may have a ring recess 114 configured to receive a head 116 of the retainer connector 112. The retainer connector 112 may secure the retainer ring 110 to the elongated shaft 86 through secured receipt in a bore 118 within the elongated shaft 86, such as by way of a threaded connection with the bore 118.

The vehicle mount assembly 28 may include one or more of a housing 120, a bias member cover 122, and a housing cover 124. The vehicle mount assembly 28 may be made of aluminum in whole or in part for the advantage of corrosion resistance and ease of manufacture.

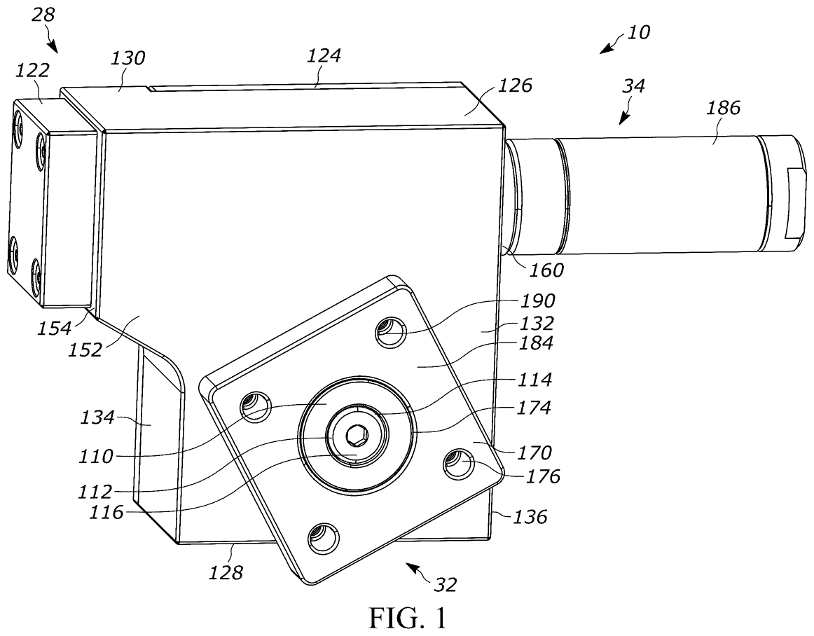

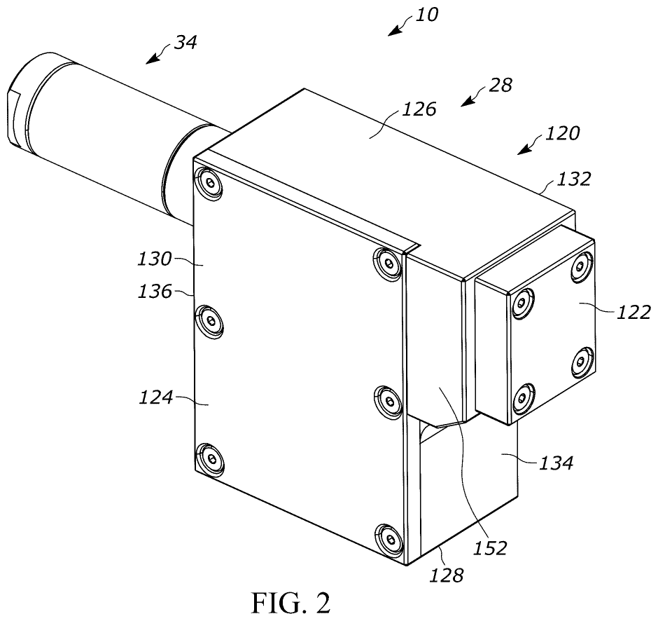

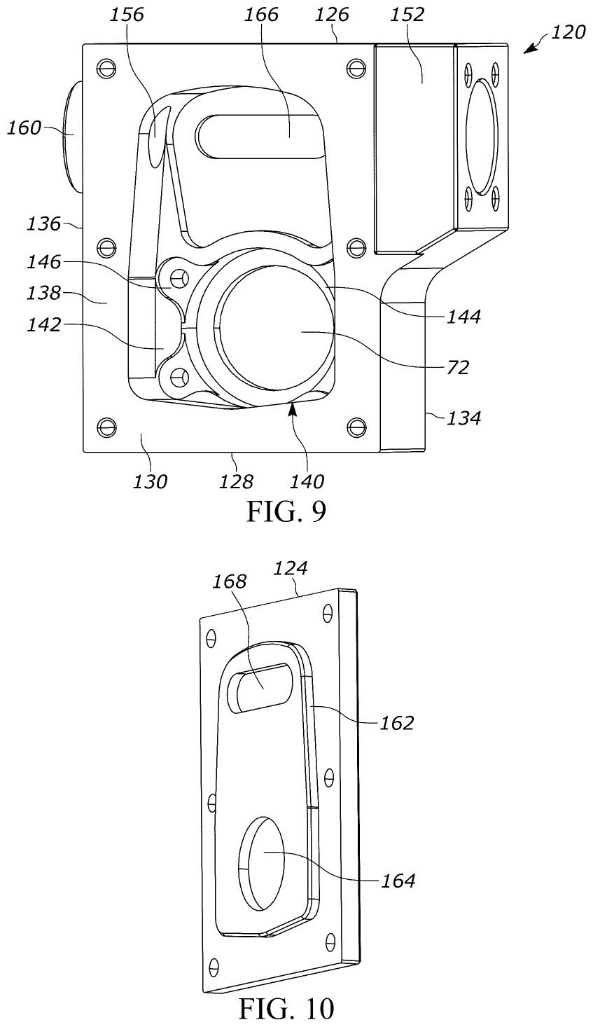

With reference to at least FIGS. 1, 2, 9, and 10, the housing 120 may comprise a top wall 126, a bottom wall 128, a first side wall 130, a second side wall 132, a front wall 134, and a rear wall 136; all of which form a cavity 138 within the housing 120. The first side wall 130 may have a housing opening 140 configured to insert the dynamic assembly 26 into the cavity 138 during assembly of the overheight assembly 10. The housing cover 124 may connect to the first side wall 130 and cover the housing opening 140.

The second side wall 132 may have an interior face 142 with a bearing recess 144 and a bearing retainer recess 146 formed therein to receive and engage the bearing 50 and the bearing retainer 48, respectively. The bearing recess 144 and the bearing retainer recess 146 may be formed such that they matingly engage the bearing 50 and the bearing retainer 48, respectively. In this way, the bearing 50 is sealed for water resistance, as well as smooth and reliable rotation of the overheight assembly 10 as disclosed herein. The shaft opening 72 may also extend through the second side wall 132. On an exterior face 148 of the second side wall 132, a drip edge 150 may protrude and surround the shaft opening 72.

The housing 120 may have a bias member compartment 152 that protrudes forwardly from the housing 120. The front wall 134 may have a bias member opening 154 that provides access to the cavity 138 and which may be covered by the bias member cover 122. As seen in at least FIGS. 3-5, when assembled, the bias member 38 is at least partially positioned within the bias member compartment 152 and retained between the trunnion 36 and the air suspension system 12 and/or the front wall 134. The bias member cover 122 provides access to assemble the bias member 38 with the overheight assembly 10 and/or allow for the repair or replacement of the bias member 38.

The rear wall 136 of the housing 120 may have an actuator opening 156 through which the actuator assembly 34 may be positioned through to engage and operate the dynamic assembly 26 as disclosed further herein. An actuator collar 160 may encircle the actuator opening 156 to provide support to the actuator assembly 34 and enhance rigidity.

The housing cover 124 may have an interior face 162 (or a second interior face) that is raised or recessed with a cap recess 164 formed therein. The cap recess 164 may be configured to receive and engage the cap 90 of the rotator shaft 46 thereby providing support to the rotator shaft 46.

A first arm channel 166 may be formed in the interior face 162 of the housing cover 124 (or the first side wall 130), which receives one of the trunnion arms 56. A second arm channel 168 may be formed in the second side wall 132, which receives the other of the trunnion arms 56. Alternatively, only one of the first arm channel 166 and the second arm channel 168 is present when the trunnion 36 has a single arm. The first arm channel 166 and the second arm channel 168 are configured to permit the trunnion arms 56 to travel along a length of the first arm channel 166 and the second arm channel 168 while otherwise restricting or prohibiting movement of the trunnion arms 56 beyond the length.

The mount assembly 32 may comprise one or more of a mount plate 170, a mount collar 172, a mount recess 174, and one or a plurality of valve connector openings 176. The mount assembly 32, in whole or in part, may be made of aluminum to improved corrosion resistance and ease of manufacture.

The mount collar 172 may extend from a first face 178 of the mount plate 170 and encircle the shaft opening 72. The mount collar 172 may be sized and shaped to fit within and be encircled by the drip edge 150 of the housing 120. In this way, the drip edge 150 provides a water egress to limit or eliminate the potential for water to enter the housing 120. The advantage of this configuration is enhanced if the mount collar 172 is press fit into the drip edge 150, which provides the further advantage of limiting vibration of dynamic parts of the overheight assembly 10.

A diameter of the mount collar 172 and/or the mount plate 170 may have a second key channel 180 recessed in their diameter along a length of the shaft opening. The second key channel 180 may be formed as a rectangular recess. A second key 182, which may be formed as a rectangular prism or cuboid, may be received within the elongated key channel 88 and also be received within the second key channel 180. In this way, the rotator 40, the rotator shaft 46, and the mount assembly 32 are timed together. The second key 182 may be sized and shaped to extend a length no greater than a distance extending from the mount recess 174 to the end of the mount collar 172. When assembled, the mount collar 172 may engage the bearing 50 opposite of the bearing retainer 48. In this way, the bearing 50 may be positioned between the bearing retainer 48 and first key 98 on one side and the mount collar 172 and the second key 182 on the opposite side. The first key 98 and the second key 182 may be made of steel to enhance strength and rigidity to ensure proper timing.

The mount recess 174 may be formed in a second face 184 opposite the first face 178. The mount recess 174 may be sized and shaped to receive the retainer 52 within the mount recess 174 or flush with the second face 184. When the retainer ring 110 is a washer, the washer may be made of aluminum to avoid corrosion and may be configured to provide sufficient clearance to allow a consistent clamping force to all translation of rotation force from the rotator 40, the rotator shaft 46, the bearing 50, and the mount plate 170.

The plurality of valve connector openings 176 are positioned about the mount plate 170 and are configured to receive one or a plurality of valve connectors 190 to connect the overheight assembly 10 to height control valve 14. The plurality of valve connectors 190 may include a lock nut to provide the advantage of resist vibration.

The actuator assembly 34 may include one or more of an actuator 186 and a rotator connector 188 (such as a trunnion pin). The actuator 186 may be an air cylinder, a round body cylinder, or other operatively similar elements, which is operatively connected to the vehicle 16 such that the overheight assembly 10 may be operated manually by an occupant of the vehicle 16 and/or automatically. The use of an air cylinder provides the advantage of holding force to resist accidental rotation due to road vibrations. The actuator 186 may be secured to the housing 120 such as by connection to the actuator collar 160, including by way of a threaded connection. The actuator 186 may be operatively connected to the rotator 40, including by way of connection to the trunnion 36, by the rotator connector 188 or directly including through a threaded connection.

With reference to FIGS. 14-21, an exemplary operation of the overheight assembly 10 is depicted. The vehicle mount assembly 28 is statically mounted to the vehicle 16 and the mount assembly 32 is dynamically (e.g., rotatably) mounted to the height control valve 14. The control arm 22 of the height control valve 14 is connected to the linkage 18, which connects to the axle 20 of the vehicle 16.

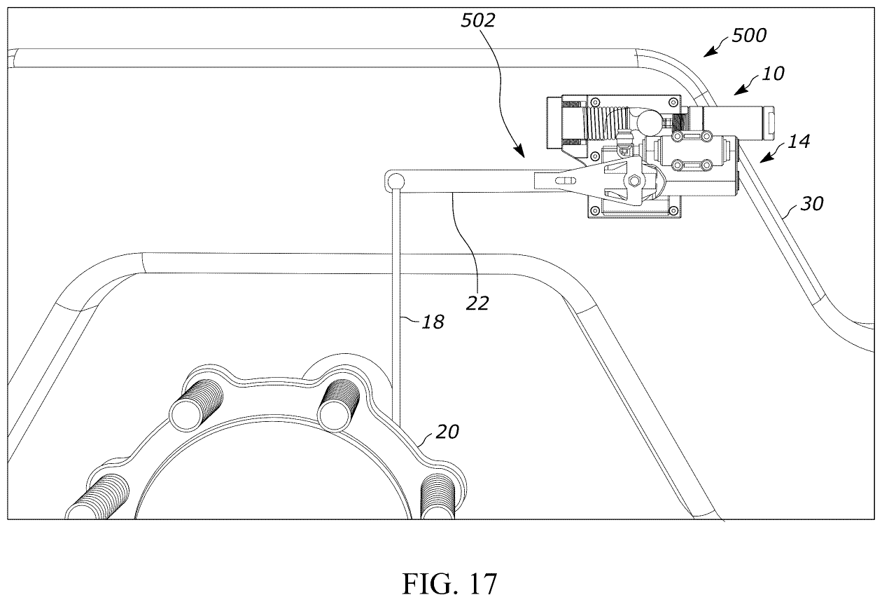

In FIGS. 17-19, the overheight assembly 10 is in a standard configuration 500, which may mimic a conventional static mount of the height control valve 14 to the vehicle 16. In the standard configuration 500, the height control valve 14 operates conventionally. As seen in FIG. 17, the control arm 22 is in a neutral position 502 and the height control valve 14 blocks airflow to the air suspension system 12.

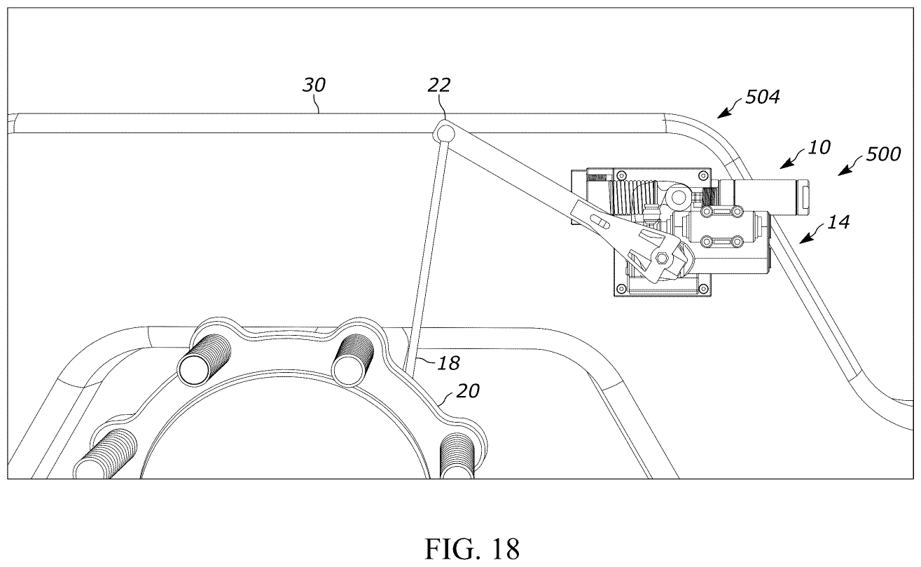

In FIG. 18, the distance between the axle 20 and the height control valve 14 is reduced, such as when a load is added to the vehicle 16. As the distance is reduced, the control arm 22 is displaced upwards to an air supply position 504 and the height control valve 14 operates to supply air to the air suspension system 12, which ceases when the neutral position 502 is reached by the control arm 22 as seen in FIG. 17.

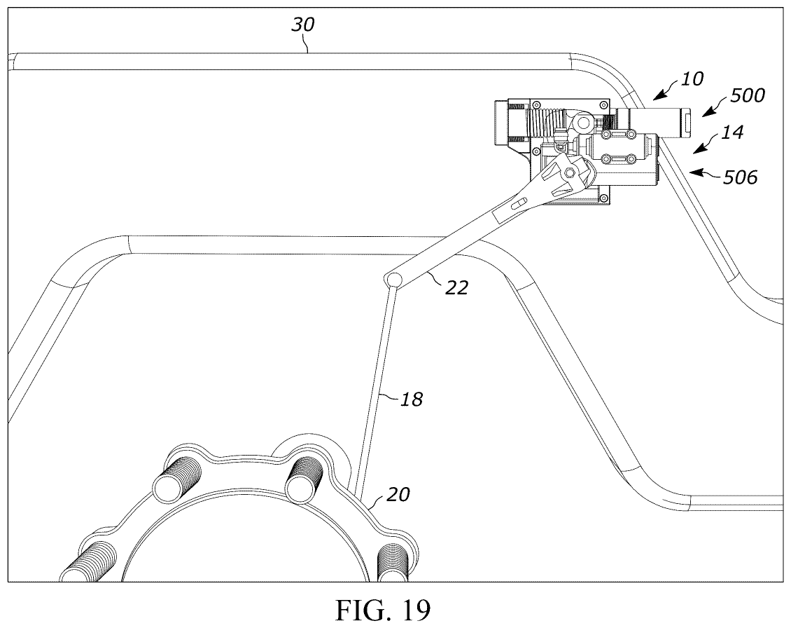

In FIG. 19, the distance between the axle 20 and the height control valve 14 is increased, such as when a load is removed from the vehicle 16. As the distance is increased, the control arm 22 is displaced downwards to an exhaust position 506 and the height control valve 14 operates to exhaust air pressure from the air suspension system 12, which ceases when control arm 22 reaches the neutral position 502 as seen in FIG. 17.

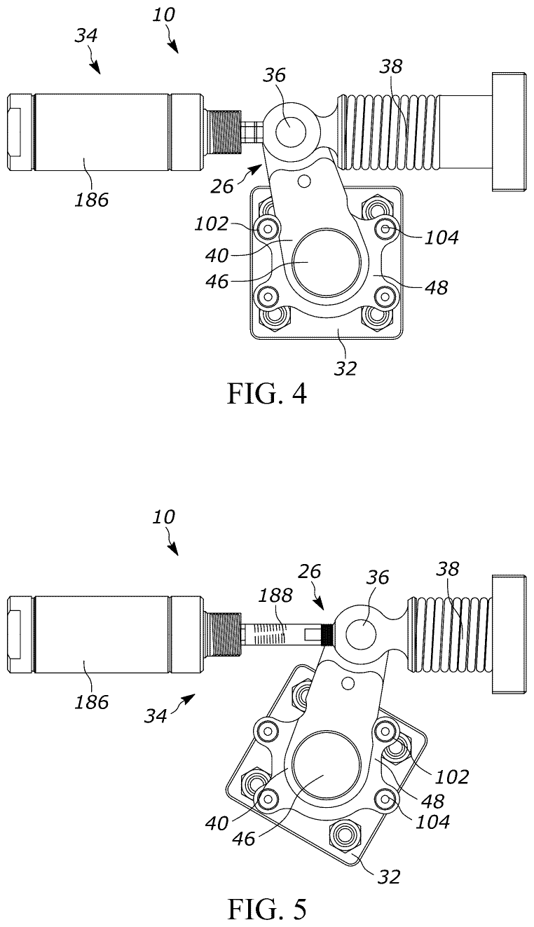

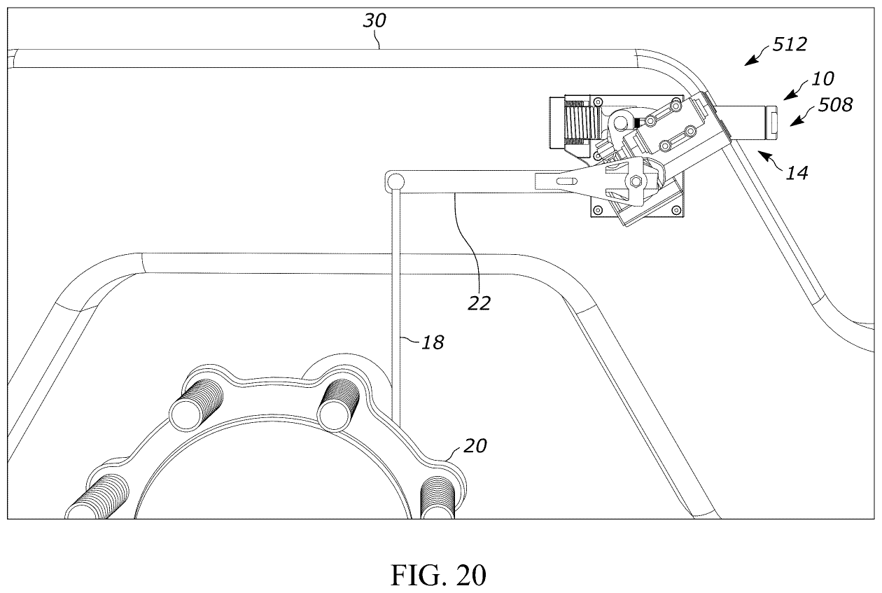

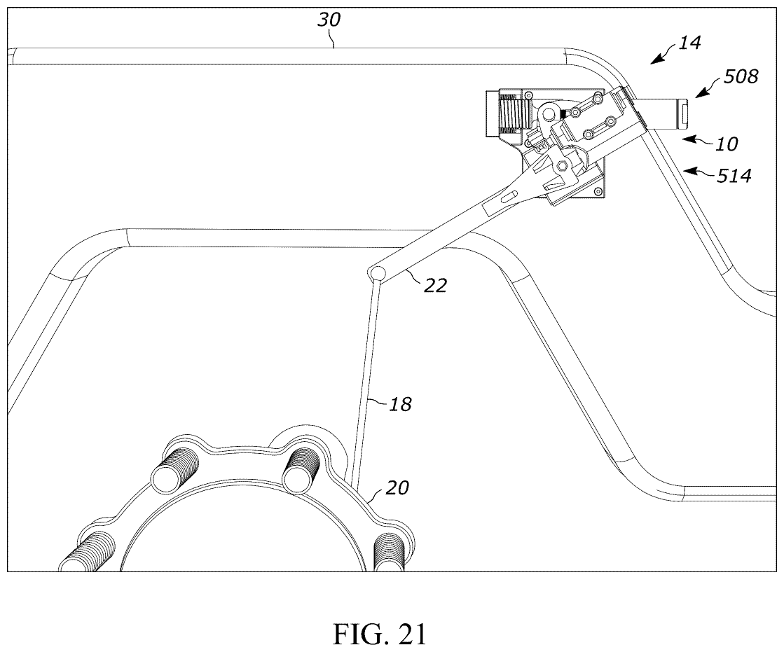

In FIGS. 20 and 21, the overheight assembly 10 is in an overheight configuration 508. As seen in FIGS. 4, 5, 20, and 21, in the overheight configuration 508, the actuator 186 applies force to the trunnion 36 to overcome opposing force of the bias member 38. As the trunnion 36 travels, the trunnion arms 56 may be guided horizontally by the first arm channel 166 and/or the second arm channel 168 while the trunnion opening 70 in the rotator 40 allows for vertical variation as the trunnion 36 travels. The trunnion 36 pushes the rotator 40 with along the path of travel. Because the rotator 40 is keyed with the rotator shaft 46, the two are timed together. Likewise, the rotator shaft 46 is keyed to the mount plate 170 such that all are timed together. The bearing 50 facilitates movement by being positioned between the rotator 40 and the mount plate 170.

As the mount plate 170 rotates, the height control valve 14 mounted thereto rotates and displaces the control arm to the overheight air supply position 512. In the air supply position 504, seen in FIG. 20, the height control valve 14 operates to supply air to the air suspension system 12, which ceases when the overheight neutral position 514 is reached as seen in FIG. 21.

To revert, the overheight assembly 10 is returned to the standard configuration 500 as seen in FIGS. 17-19. In doing so, the actuator 186 is deactivated and the opposing force of the bias member 38 returns the rotator 40 and due to the keyed connection with the mount plate 170, the height control valve 14 is no longer displaced. However, because the air suspension system 12 has been filled beyond conventional norms, the control arm 22 is in the exhaust position 506 as seen in FIG. 19. Upon adequate exhaustion, the control arm 22 is returned to the neutral position 502 and airflow is blocked by the height control valve 14.

Therefore, an overheight assembly 10 has been provided that is easily retrofitted into an existing air ride suspension, is simple to install, is simple to use, is cost-effective, does not require additional valving, and improves upon the art.

From the above discussion and accompanying figures and claims it will be appreciated that the overheight assembly 10 offers many advantages over the prior art. Although the present disclosure and its advantages have been described in detail, it should be understood that various changes, substitutions, modifications, and alterations can be made herein without departing from the technology of the disclosure as defined by the appended claims. The scope of the present application is not intended to be limited to the particular configurations of the process, machine, manufacture, composition of matter, means, methods and steps described in the specification only expressly stated otherwise. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An overheight assembly for an air suspension system comprising:
a dynamic assembly received at least partially within a vehicle mount assembly;
an actuator assembly operatively connected to the dynamic assembly; and
a mount assembly dynamically connected to the dynamic assembly.

2. The overheight assembly of claim 1 further comprising a height controller mounted to the mount assembly.

3. The overheight assembly of claim 2 further comprising the height controller connected to an axle of a vehicle and the vehicle mount assembly mounted to the vehicle above the axle.

4. The overheight assembly of claim 3 further comprising the dynamic assembly having a standard configuration and an overheight configuration, wherein an orientation of the height controller in relation to the axle and the vehicle mount assembly is different for the standard configuration and the overheight configuration.

5. The overheight assembly of claim 1 further comprising the dynamic assembly having a rotator and a rotator shaft timed to one another by a first key.

6. The overheight assembly of claim 5 further comprising the rotator shaft timed to the mount assembly by a second key.

7. The overheight assembly of claim 6 wherein the first key is received in a first key channel of the rotator and an elongated key channel of the rotator shaft; and the second key is received in a second key channel of the mount assembly and the elongated key channel of the rotator shaft.

8. The overheight assembly of claim 1 further comprising the dynamic assembly having a rotator shaft that extends through a rotator, a bearing, and a sidewall of the vehicle mount assembly to at least partially within the mount assembly.

9. The overheight assembly of claim 8 further comprising a retainer received in an end of the rotator shaft; and the mount assembly positioned between a retainer ring of the retainer and the rotator shaft.

10. The overheight assembly of claim 8 further comprising the rotator shaft having a cap connected to an opposite end of the rotator shaft, wherein the cap is received in a cap recess inside of the vehicle mount assembly.

11. The overheight assembly of claim 1 further comprising the dynamic assembly having a trunnion having trunnion body and a pair of trunnion arms extending from opposite sides of the trunnion body; the trunnion arms received through a trunnion slot that extends through a first rotator arm and a second rotator arm of a rotator.

12. The overheight assembly of claim 11 further comprising one of the pair of trunnion arms received in a first arm channel within a housing of the vehicle mount assembly; and the other of the pair of trunnion arms received in a second arm channel within the housing.

13. The overheight assembly of claim 1 further comprising the vehicle mount assembly having a housing with a cavity; a side wall within the housing having a bearing recess, a bearing retainer recess, and a shaft opening.

14. The overheight assembly of claim 13 further comprising the side wall of the housing having a drip edge encircling the shaft opening; wherein the drip edge protrudes from an exterior surface of the side wall.

15. The overheight assembly of claim 14 further comprising the mount assembly having a mount collar that extends from a mount plate; wherein the mount collar is press fit within the drip edge.

16. The overheight assembly of claim 14 further comprising the housing having a housing cover with a cap recess; and the housing having a bias member compartment on a front wall and an actuator opening through a rear wall.

17. The overheight assembly of claim 1 further comprising the actuator assembly having an actuator operatively connected to trunnion of the dynamic assembly; and a bias member connected to the trunnion opposite of the actuator.

18. The overheight assembly of claim 17 wherein the bias member is an expansion bias spring.

19. The overheight assembly of claim 18 further comprising the trunnion having a trunnion plate that is received within an end of the expansion bias spring.
